(19) United States
(12) Patent Application Publication
(10) Pub. No.: US 2018/0139599 A1
(43) Pub. Date: May 17, 2018

(54) USER DEVICE AND BASE STATION

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 15/563,968

(22) PCT Filed: Mar. 23, 2016
(86) PCT No.: PCT/JP2016/059258

§ 371 Date: Oct. 3, 2017

(30) Foreign Application Priority Data
Apr. 9, 2015 (JP) 2015-080418

(51) Int. Cl. H04W 8/00; H04W 76/14; H04W 92/18; H04W 28/06; H04W 48/16

(52) U.S. Cl. CPC H04W 8/005; H04W 76/14; H04W 72/0406; H04W 28/065; H04W 48/16; H04W 92/18

(57) ABSTRACT

A user device, which is used in a mobile communication system supporting D2D communication, includes an acquirer that obtains a discovery message to be transmitted to another user device; a generator that divides the discovery message into two or more discovery messages, and stores the two or more discovery messages in two or more resource regions of a physical channel for the D2D communication to generate a transmission signal to be transmitted to the other user device; and a transmitter that transmits the transmission signal.

### TECHNICAL FIELD

The present invention relates to a user device and a base station.

### BACKGROUND ART

In a mobile communication system such as the current Long Term Evolution (LTE), it is common that user devices communicate with base stations and communicate with each other via the base stations. However, various technologies related to Device-to-Device (D2D) communication where user devices communicate directly with each other have been proposed.

Particularly, for D2D communication in LTE, there have been proposed a “communication” service that enables data communication such as Voice over Internet Protocol (VoIP) communication between user devices, and a “discovery” service where a transmitting user device transmits a discovery message including its own ID and thereby allows a receiving user device to detect the transmitting user device (Non-Patent Document 1). For example, the communication service is intended to be used for “public safety” (e.g., police radio, fire radio).

In D2D communication defined in LTE, it is proposed to use a part of uplink resources that are already defined for uplink signal transmission from a user device to a base station. Also, it is proposed that the user device assists the allocation of resources used for D2D communication.

Also, in the D2D communication defined in LTE, multiple physical channels, which are different from physical channels used for communication between the base station and the user device, are newly defined for the D2D communication. For example, a physical sidelink discovery channel (PSDCH) is defined as a physical channel for transmission of a discovery message, and a physical sidelink shared channel (PSSCH) is defined as a physical channel for transmission of data in the communication service. Further, a physical sidelink control channel (PSCCH) is defined as a physical channel for reporting, for example, resource allocation of PSSCH to the receiving user device.

### RELATED-ART DOCUMENTS

### Non-Patent Documents

[Non-Patent Document 1] 3GPP TR 36.843 V12.0.1 (2014-03)
[Non-Patent Document 2] 3GPP TS 24.334 V12.2.0 (2015-03)

### DISCLOSURE OF INVENTION

### Problems to be Solved by the Invention

FIGS. 1A through 1C are drawings used to describe problems to be solved. FIG. 1A illustrates a discovery message transmitted from a transmitting user device. FIG. 1B illustrates a format of a discovery message defined in the D2D communication in LTE. As illustrated by FIG. 1A, the discovery message is periodically transmitted using, for example, PSDCH. Also, as illustrated by FIG. 1B, the discovery message includes a field that corresponds to a header and contains a message type, a payload field for containing a message body, and a cyclic redundancy check (CRC) field. The total bit length of the field for containing a message type and the payload field is defined as 232 bits.

FIG. 1C illustrates data that is used for communication and transmitted from a transmitting user device. Here, a control signal is transmitted via PSCCH and data is transmitted via PSSCH. As described above, data communication such as VoIP communication between user devices has been proposed as a communication service. Accordingly, to enable transmission of multiple media access control packet data units (MAC PDUs), it is designed to periodically and consecutively allocate radio resources to the control signal and the data at relatively short intervals.

Here, vehicle-to-vehicle communication in Intelligent Transport Systems (ITS) is an example of a future service based on D2D communication. A cooperative awareness message (CAM) defined by the European Telecommunications Standards Institute (ETSI) is an example of a message used for the vehicle-to-vehicle communication in ITS. The maximum data size of CAM is defined as 500 bytes.

Thus, considering the future applications of D2D communication, it is expected that the data size of a discovery message used for the discovery service becomes greater in the future. However, in the D2D communication of the current LTE, no method is defined to transmit a discovery message with a data size of 232 bits or greater by using PSDCH.

Here, it may be possible to transmit a discovery message with a large data size by using physical channels (PSCCH and PSSCH) defined for the communication service. However, physical channels for the communication service are designed such that radio resources are periodically and consecutively allocated at relatively short intervals. Therefore, using those physical channels for transmission of a discovery message, which does not need to be transmitted frequently, may result in wasteful allocation of radio resources. Also, wasteful allocation of radio resources may increase the power consumption of the user device.

One object of this disclosure is to solve or reduce the above-described problems, and to provide a technology that makes it possible to transmit a discovery message with a large data size.

### Means for Solving the Problems

An aspect of this disclosure provides a user device used in a mobile communication system supporting D2D communication. The user device includes an acquirer that obtains a discovery message to be transmitted to another user device; a generator that divides the discovery message into two or more discovery messages, and stores the two or more discovery messages in two or more resource regions of a physical channel for the D2D communication to generate a transmission signal to be transmitted to the other user device; and a transmitter that transmits the transmission signal.

Another aspect of this disclosure provides a user device used in a mobile communication system supporting D2D communication. The user device includes an acquirer that obtains a discovery message to be transmitted to another user device; a generator that stores the discovery message in a resource region of a physical channel used for the D2D communication, stores offset information indicating a location of the resource region in a physical channel for a control signal used in the D2D communication, and thereby generates a transmission signal to be transmitted to the other user device; and a transmitter that transmits the transmission signal.

Another aspect of this disclosure provides a base station used in a mobile communication system supporting D2D communication. The base station includes a receiver that receives a resource allocation request from a user device; an allocator that allocates two or more resource regions of a physical channel used for the D2D communication to the user device based on the resource allocation request, the two or more resource regions being arranged in a frequency direction or a time direction and associated with each other; and a reporter that reports the allocated two or more resource regions to the user device.

### Advantageous Effect of the Invention

This disclosure provides a technology that makes it possible to transmit a discovery message with a large data size.

### BRIEF DESCRIPTION OF THE DRAWINGS

FIG. 1A is a drawing used to describe problems to be solved;

FIG. 1B is a drawing used to describe problems to be solved;

FIG. 1C is a drawing used to describe problems to be solved;

FIG. 2 is a drawing illustrating an example of a configuration of a communication system according to an embodiment;

FIG. 3 is a drawing used to describe a related-art PSDCH resource allocation method;

FIG. 4 is a drawing illustrating a mapping method (1) for mapping a discovery message to PSDCH according to an embodiment;

FIG. 5 is a drawing illustrating a mapping method (2) for mapping a discovery message to PSDCH according to an embodiment;

FIG. 6 is a drawing illustrating a mapping method (3) for mapping a discovery message to PSDCH according to an embodiment;

FIG. 7 is a drawing illustrating an example of a discovery message format (1) according to an embodiment;

FIG. 8 is a drawing illustrating an example of a discovery message format (2) according to an embodiment;

FIG. 9 is a sequence chart illustrating an example of a resource allocation process in a communication system according to an embodiment;

FIG. 10 is a drawing illustrating exemplary virtual resource pools set in a PSDCH resource pool;

FIG. 11 is a drawing used to describe a related-art method of allocating PSCCH and PSSCH resources;

FIG. 12 is a drawing illustrating exemplary repetition intervals of PSCCH and PSSCH resource pools;

FIG. 13 is a drawing illustrating an example of a time offset setting (1) according to an embodiment;

FIG. 14 is a drawing illustrating an example of a time offset setting (2) according to an embodiment;

FIG. 15 is a drawing illustrating an example of a time offset setting (3) according to an embodiment;

FIG. 16 is a drawing illustrating a part of related-art SCI (format 0);

FIG. 17 is a drawing illustrating a related-art MAC PDU format;

FIG. 18 is a sequence chart illustrating an example of a resource allocation process in a communication system according to an embodiment;

FIG. 19 is a drawing illustrating a Sidelink BSR MAC CE format;

FIG. 20 is a drawing illustrating exemplary virtual resource pools set in a PSSCH resource pool(s);

FIG. 21 is a drawing illustrating an example of a functional configuration of a base station according to an embodiment;

FIG. 22 is a drawing illustrating an example of a functional configuration of a user device according to an embodiment;

FIG. 23 is a drawing illustrating an example of a hardware configuration of a base station according to an embodiment; and

FIG. 24 is a drawing illustrating an example of a hardware configuration of a user device according to an embodiment.

### DESCRIPTION OF EMBODIMENTS

Embodiments of the present invention are described below with reference to the accompanying drawings. Embodiments described below are examples, and the present invention is not limited to those embodiments. For example, although it is assumed that a communication system according to the embodiments conforms to LTE, the present invention is not limited to LTE and may also be applied to other types of systems. In the specification and the claims of the present application, “LTE” is used in a broad sense and may indicate not only a communication scheme corresponding to 3GPP release 8 or 9, but also a communication scheme corresponding to 3GPP release 10, 11, 12, 13, 14, or later. In the descriptions below, signals used for the discovery service and the communication service in D2D communication are collectively referred to as a “D2D signal”.

### <Outline>

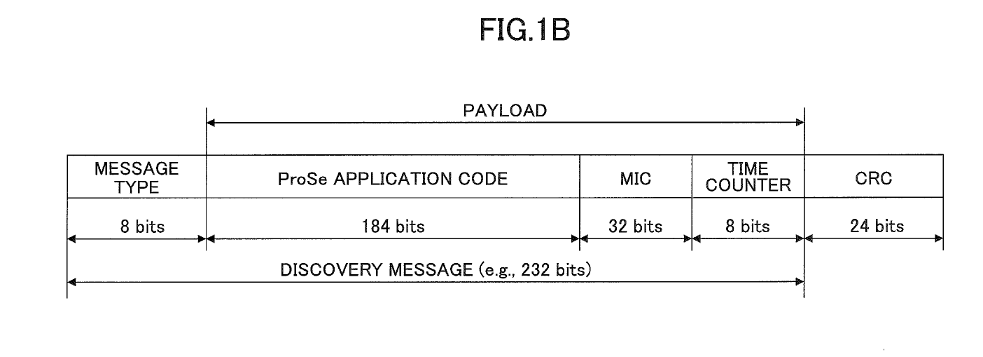

FIG. 2 is a drawing illustrating an example of a configuration of a communication system according to an embodiment. As illustrated by FIG. 2, the communication system of the present embodiment includes a base station 1, a transmitting user device 2a that transmits a D2D signal, and a receiving user device 2b that receives the D2D signal. The base station 1, for example, allocates a resource pool used for transmission and reception of the D2D signal and a radio resource used by the transmitting user device 2a to transmit the D2D signal by using broadcast information (system information) of a macro cell or a radio resource control (RRC). Here, the D2D signal is transmitted and received between the transmitting user device 2a and the receiving user device 2b using uplink radio resources. A resource pool indicates regions of the uplink radio resources allocated for transmission and reception of the D2D signal. In the descriptions below, the transmitting user device 2a and the receiving user device 2b may be collectively referred to as a “user device(s) 2”.

The base station 1 wirelessly communicates with the user device 2. The base station 1 is comprised of hardware resources including a CPU such as a processor; a memory such as a ROM, a RAM, or a flash memory; an antenna(s) for communicating with, for example, the user device 2, and a communication interface for communicating with, for example, neighboring base stations. Functions and processes of the base station 1 may be implemented by processing data and executing programs stored in a memory by a processor. However, the hardware configuration of the base station 1 is not limited to the above example, and the base station 1 may have any other appropriate hardware configuration.

The user device 2 includes a function to wirelessly communicate with the base station 1 and other user devices 2. The user device 2 is, for example, a cellphone, a smartphone, a tablet computer, a mobile router, or a wearable terminal. The user device 2 may be implemented by any device including a D2D communication function. The user device 2 is comprised of hardware resources including a CPU such as a processor; a memory such as a ROM, a RAM, or a flash memory; and an antenna(s) and a radio frequency (RF) device for communicating with the base station 1. Functions and processes of the user device 2 may be implemented by executing data and processing programs stored in a memory by a processor. However, the hardware configuration of the user device 2 is not limited to the above example, and the user device 2 may have any other appropriate hardware configuration.

In the communication system of the present embodiment, a discovery message with a large data size is transmitted from the user device 2a to the user device 2b. Below, a process for transmitting a discovery message with a large data size using PSDCH and a process for transmitting a discovery message with a large data size using PSSCH and PSCCH are described.

### <Transmission Process Using PSDCH>

### (Resource Allocation Method and Discovery Message Storing Method)

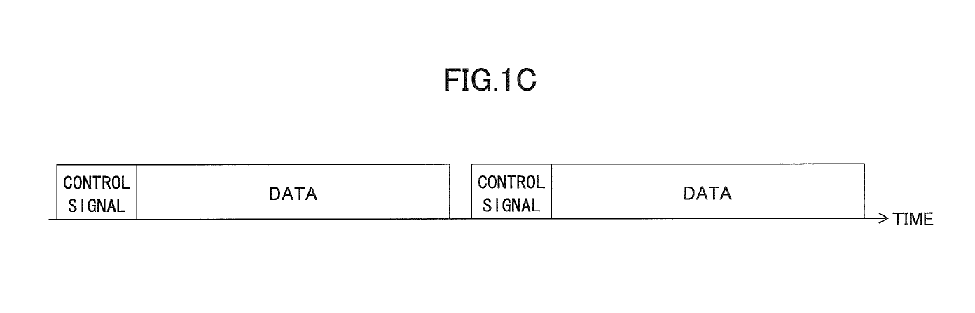

FIG. 3 is a drawing used to describe a related-art PSDCH resource allocation method. First, a related-art PSDCH resource allocation method is described with reference to FIG. 3. As illustrated in FIG. 3 (a), among all uplink resources, a PSDCH resource pool is allocated inside of resources allocated for a physical uplink control channel (PUCCH). The PSDCH resource pool is divided into an upper part and a lower part. Also, the PSDCH resource pool is allocated periodically at an interval of 320 ms or greater in the time axis direction. This interval is reported from the base station 1 to the user device 2 via, for example, system information or an RRC signal. One discovery message is stored in two physical resource blocks (PRB) included in one subframe.

Multiple resources each storing one discovery message may be mapped in the PSDCH resource pool in the same interval. For example, in PSDCH according to 3GPP release 12, up to four resources can be mapped in the PSDCH resource pool in the same interval using frequency hopping. The user device 2 stores discovery messages of the same content in these resources and thereby transmits the discovery messages.

FIG. 3 (b) illustrates a case where the discovery message is transmitted four times. Each of resources (R1 through R4) in FIG. 3 (b) is composed of two resource blocks, and one discovery message is stored in each of the resources. In the example of FIG. 3 (b), four discovery messages of the same content are mapped to the resources sequentially from the upper-left resource (R1) to the lower-right resource (R4). However, this is for illustration purposes only, and the discovery messages are not necessarily mapped in this order on the frequency axis.

Also, the user device 2 can transmit multiple different discovery messages in the PSDCH resource pool in the same interval. In this case, each of the different discovery messages is mapped to one or more resources in the PSDCH resource pool in the same interval.

### [Mapping Method (1)]

Next, methods of the present embodiment for mapping a discovery message with a large data size to resources of PSDCH are described in more detail. In a discovery message mapping method (1), the user device 2 divides a discovery message with a large data size into parts, and stores the parts of the discovery message in resources allocated in a manner similar to the related-art PSDCH resource allocation method.

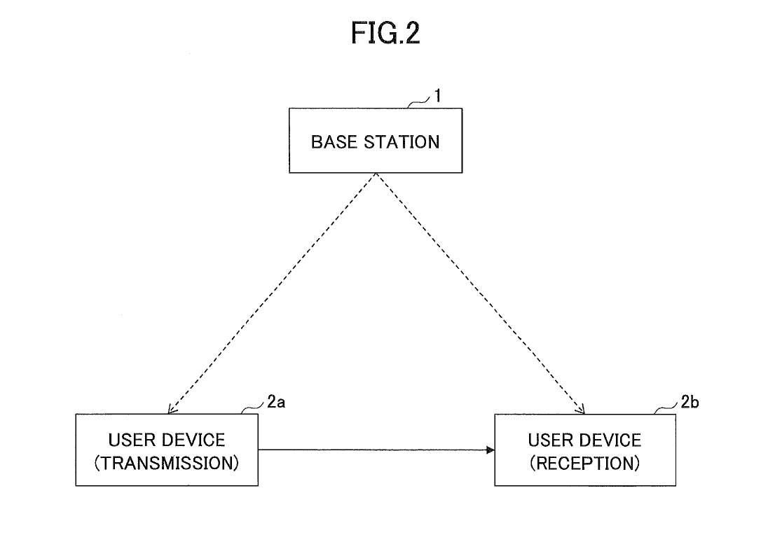

FIG. 4 is a drawing illustrating a mapping method (1) for mapping a discovery message to PSDCH according to an embodiment. In FIG. 4, similarly to FIG. 3 (b), each region is composed of two resource blocks. Also in FIG. 4, the locations of four regions are examples, and the regions may not necessarily be mapped in the illustrated order on the frequency axis.

As illustrated by FIG. 4 (a), the user device 2 may divide a discovery message with a large data size into two discovery messages, and store the two discovery messages in two resources. Also, instead of randomly storing the two discovery messages in multiple resources, the user device 2 may store the two discovery messages in resources in a predetermined order. For example, in the example of FIG. 4 (a), the user device 2 stores the two discovery messages in a resource R1 and a resource R2 in order of time along the time axis, and also stores the same two discovery messages in a resource R3 and a resource R4. With the example of FIG. 4 (a), although the repetition rate of the discovery message is halved, it is possible to store a discovery message with a large data size by using the related-art PSDCH resource allocation method.

Also, as illustrated by FIG. 4 (b), the user device 2 may be configured to divide a discovery message with a large data size into two discovery messages, store the two discovery messages in the resource R1 and the resource R3 in order of time along the time axis, and also store the same two discovery messages in the resource R2 and the resource R4. Similarly to FIG. 4 (a), although the repetition rate of the discovery message is halved with the example of FIG. 4 (b), it is possible to store a discovery message with a large data size by using the related-art PSDCH resource allocation method.

Also, as illustrated by FIG. 4 (c), the data size that can be stored in each of the resources (R1 through R4) may be increased, and a discovery message with a large data size may be stored in each of the resources. For example, a modulation and coding scheme (MCS) that is higher than the MCS used for the related-art PSDCH may be used. In the related-art PSDCH, only Quadrature Phase Shift Keying (QPSK) is defined. The method of FIG. 4 (c) may employ a modulation scheme such as 16 QAM (Quadrature Amplitude Modulation) or 64 QAM that enables transmission of a larger amount of data.

In the examples of FIG. 4 (a) and FIG. 4 (b), the user device 2 divides a discovery message into two parts. However, the user device 2 may also be configured to divide a discovery message into three or four parts.

Although this method reduces the repetition rate of a discovery message, this method enables the user device 2 to store a discovery message with a larger data size in resources.

The discovery message mapping method (1) is described above. The discovery message mapping method (1) enables the communication system to transmit a discovery message with a large data size without changing the related-art PSDCH resource allocation method.

### [Mapping Method (2)]

Next, a discovery message mapping method (2) is described. In the discovery message mapping method (2), the user device 2 divides a discovery message with a large data size into parts, and stores the parts of the discovery message in a larger number of resources than in the related-art PSDCH resource allocation method.

More specifically, according to the discovery message mapping method (2), in addition to resources allocated by the related-art PSDCH resource allocation method, additional resources are repeatedly mapped in the frequency direction or the time-axis direction in the PSDCH resource pool in the same interval. Also, the resources allocated by the related-art PSDCH resource allocation method are associated one-to-one with the additional resources. This enables the transmitting user device 2a and the receiving user device 2b to recognize the locations where the additional resources are mapped.

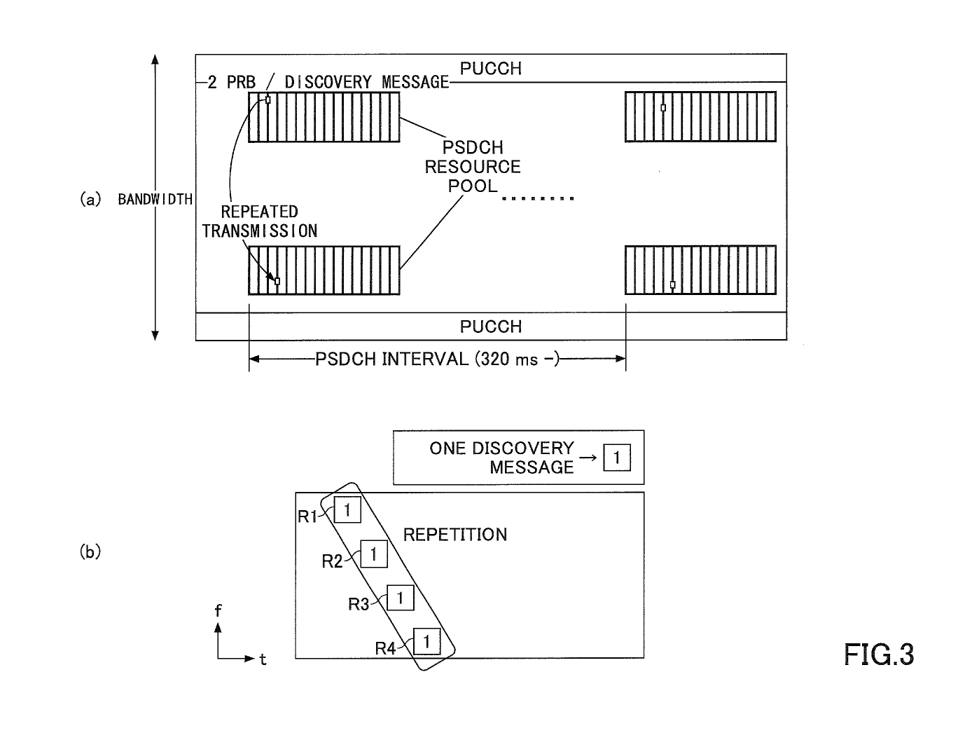

FIG. 5 is a drawing illustrating a mapping method (2) for mapping a discovery message to PSDCH according to an embodiment. As illustrated by FIG. 5 (a), in addition to resources (R1, R3, R5, and R7) allocated by the related-art resource allocation method, new resources (R2, R4, R6, and R8) that are adjacent to the resources (R1, R3, R5, and R7) in a predetermined frequency direction may be allocated.

The user device 2 divides a discovery message with a large data size into two discovery messages, and stores the two discovery messages in two resources R1 and R2 that are consecutive in the frequency direction. Also, the user device 2 repeatedly stores the same discovery messages in the resources R3 and R4, the resources R5 and R6, and the resources R7 and R8.

Also, as illustrated by FIG. 5 (b), in addition to resources (R1, R2, R3, and R4) allocated by the related-art resource allocation method, new resources (R5, R6, R7, and R8) that follow the resources (R1, R2, R3, and R4) in the time axis direction at a predetermined interval (e.g., X ms) may be allocated.

The user device 2 divides a discovery message with a large data size into two discovery messages, and stores the two discovery messages in two resources R1 and R5 that are arranged at a predetermined interval in the time axis direction. Also, the user device 2 repeatedly stores the same discovery messages in the resources R2 and R6, the resources R3 and R7, and the resources R4 and R8.

Also, although the number of resources allocated to the discovery message in FIG. 5 (a) and FIG. 5 (b) is two times greater than the number of resources allocated by the related-art allocation method, the number of resources allocated in the mapping method (2) may be three or more times greater than the number of resources allocated by the related-art allocation method.

Further, the user device 2 may be configured to divide a discovery message into three or more parts, and store them in resources. This method enables the user device 2 to store a discovery message with a larger data size.

The examples of FIG. 5 (a) and FIG. 5 (b) make it possible to achieve the same discovery message repetition rate as in the related-art PSDCH resource allocation method and to secure a coverage where the discovery message is transmitted. Also, in the example of FIG. 5 (a), resources are mapped consecutively in the frequency direction. This in turn makes it possible to prevent complication of terminal processes.

### [Mapping Method (3)]

Next, a discovery message mapping method (3) is described. In the discovery message mapping method (3), the user device 2 divides a discovery message with a large data size into parts, and stores the parts of the discovery message in a larger number of resources than in the related-art PSDCH resource allocation method.

More specifically, according to the discovery message mapping method (3), a larger number of resources than in the related-art PSDCH resource allocation method are repeatedly mapped at desired locations in the PSDCH resource pool in the same interval.

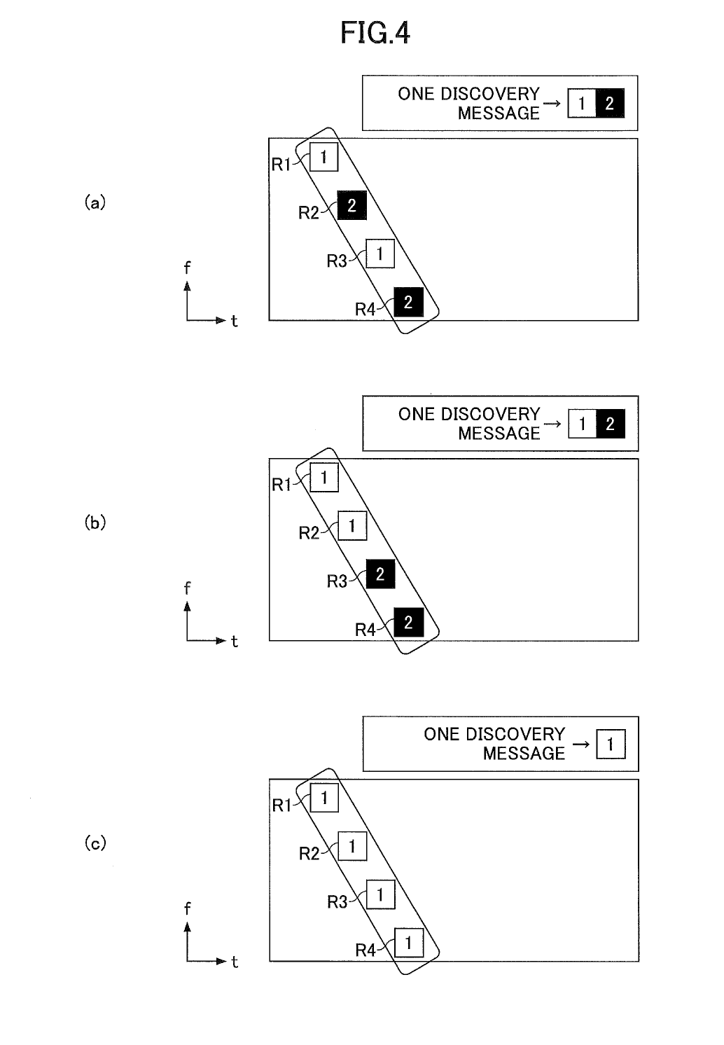

FIG. 6 is a drawing illustrating a mapping method (3) for mapping a discovery message to PSDCH according to an embodiment. For example, as illustrated by FIG. 6, in addition to resources (R1, R2, R3, and R4) allocated by the related-art resource allocation method, new resources (R5, R6, R7, and R8) may be allocated in desired locations.

The user device 2 divides a discovery message with a large data size into two discovery messages, and store the two discovery messages in two resources R1 and R5 that are arranged in the time axis direction. Also, the user device 2 repeatedly stores the same discovery messages in the resources R2 and R6, the resources R3 and R7, and the resources R4 and R8.

Also, although the number of resources allocated to the discovery message in FIG. 6 is two times greater than the number of resources allocated by the related-art allocation method, the number of resources allocated in the mapping method (3) may be three or more times greater than the number of resources allocated by the related-art allocation method. Further, the user device 2 may be configured to divide a discovery message into three or more parts, and store them in resources. This method enables the user device 2 to store a discovery message with a larger data size.

The example of FIG. 6 makes it possible to achieve the same discovery message repetition rate as in the related-art PSDCH resource allocation method and to secure a coverage where the discovery message is transmitted.

Method for mapping a discovery message with a large data size to resources of PSDCH are described above. In the D2D communication of LTE, Type 1 and Type 2B allocation schemes are defined. In the Type 1 allocation scheme, the transmitting user device 2a performs allocation of PSDCH resources by itself, and in the Type 2B allocation scheme, the base station 1 performs allocation of PSDCH resources, and reports the allocated resources to the user device 2a. The examples of FIGS. 4 through 6 can be applied to both of a case where the user device 2a performs allocation of PSDCH resources by itself and a case where the base station 1 performs allocation of PSDCH resources.

### (Format of Discovery Message)

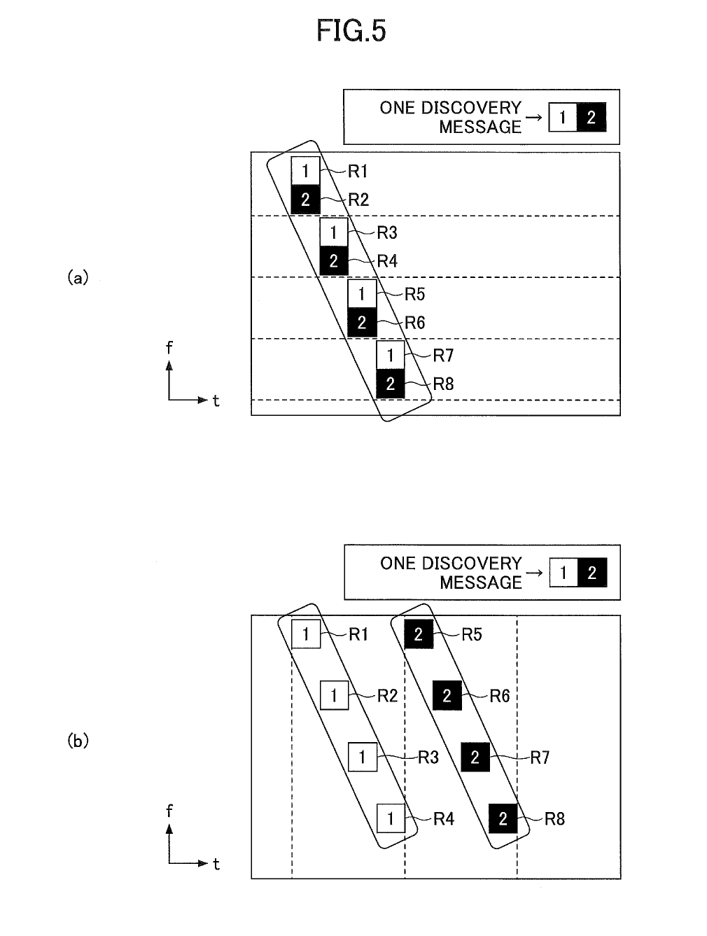

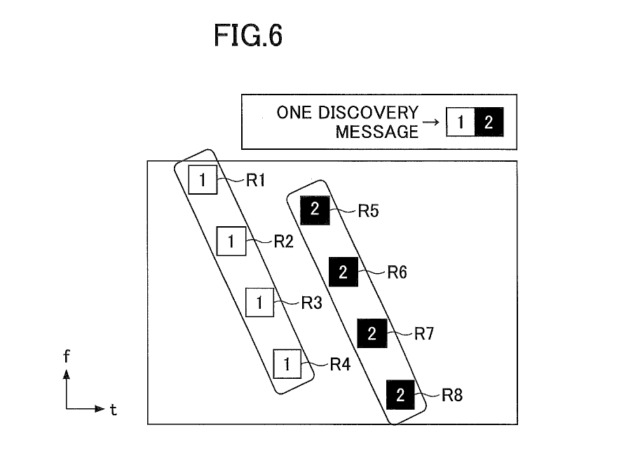

Examples of discovery message formats used for transmission of a discovery message with a large data size are described with reference to FIGS. 7 and 8.

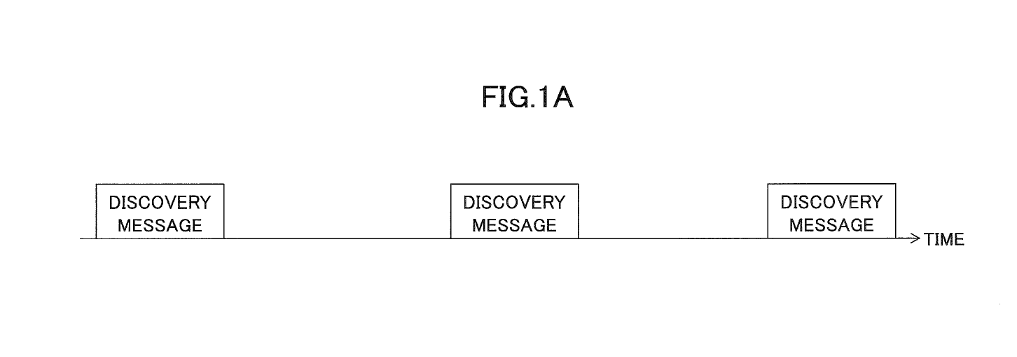

FIG. 7 is a drawing illustrating an example of a discovery message format (1) according to an embodiment. Similarly to the related-art discovery message format of FIG. 1B, the discovery message format of FIG. 7 includes a field that corresponds to a header and contains a message type, a payload field for containing a message body, and a cyclic redundancy check (CRC) field. On the other hand, in the discovery message format of FIG. 7, the payload field for storing a message body is larger than that of the related-art discovery message so that a larger amount of data can be stored.

Also, to enable the receiving user device 2b to distinguish a new type of discovery message of the present embodiment from the related-art discovery message, a value indicating the new type of discovery message may be stored in the message type.

The discovery message format of FIG. 7 is just an example, and the size of the payload field for storing a message body is not limited to any specific value.

A discovery message with the discovery message format of FIG. 7 can be stored in resources allocated by any one of the resource allocation methods illustrated by FIGS. 4 and 5. In the examples of FIGS. 4 and 5, allocated resources are mapped in association with each other. Accordingly, even when a discovery message with a large data size is stored across multiple resources, the receiving user device 2b can correctly decode the discovery message.

FIG. 8 is a drawing illustrating an example of a discovery message format (2) according to an embodiment. The discovery message format of FIG. 8 is composed of multiple discovery messages with the same data length as the related-art discovery message, and is configured to store parts of a divided discovery message with a large data size in the respective discovery messages.

The header (message type) of each discovery message contains information indicating that a part of the divided discovery message is stored, to enable the receiving user device 2b to recognize that a part of the divided discovery message is stored in the discovery message.

FIG. 8 (a) illustrates an exemplary format where a new message type (in the example of FIG. 8 (a), “divided message type”) is stored in the header (message type) of each discovery message, and a unique “message ID” is stored in the payload of each discovery message as the information indicating that a part of the divided discovery message is stored.

The transmitting user device 2a divides data (in the example of FIG. 8 (a), “payload X”) of a discovery message to be transmitted, stores the parts (in the example of FIG. 8 (a), “payload X-1” and “payload X-2”) of the divided data in multiple discovery messages, and sets a common value (in the example of FIG. 8 (a), “X”) in the “message ID” of each of the discovery messages. This configuration enables the receiving user device 2b to recognize that the parts of the divided discovery message are stored in the payload fields of received multiple discovery messages.

When the format of FIG. 8 (a) is used, the receiving user device 2b may be configured to extract the payload fields of received discovery messages and combine the extracted payload fields in the order that the discovery messages are received.

FIG. 8 (b) illustrates an exemplary format where in addition to a “message ID”, a “payload number” indicating a place in the order of combining parts of a divided discovery message and a “division number” indicating the number of the parts of the divided discovery message are stored as the information indicating that a part of the divided discovery message is stored. Here, to prevent the same message ID from being used by multiple user devices 2, a message ID or a part of a message ID may be generated using an ID or a part of an ID of the transmitting user device 2a. Also, in response to a discovery transmission request, the base station 1 may report ID information regarding a message ID to the user device 2 via upper layer signaling (e.g., an RRC signal).

The message format of FIG. 8 (b) enables the receiving user device 2b to recognize that not all of the discovery messages containing the parts of the divided data of the discovery message have been received (i.e., that one or more of the discovery messages are missing). Also, even when the order of processing the discovery messages is changed for some reason, the receiving user device 2b can combine the parts of the divided data of the discovery message in a correct order.

A discovery message(s) with one of the discovery message formats of FIG. 8 can be stored in resources allocated by any one of the resource allocation methods illustrated by FIGS. 4 through 6.

Examples of discovery message formats used to transmit a discovery message with a large data size are described above. Here, there may be a case where the receiving user device 2b is unable to know the data length of a discovery message stored in PSDCH in advance. In this case, the user device 2b tries to decode a received discovery message based on all data lengths, and determines that the discovery message is correctly decoded if the CRC matches. In the formats of FIG. 8, the data length of each discovery message is the same as the data length of the related-art discovery message. Accordingly, using the formats of FIG. 8 eliminates the need for the receiving user device 2b to try to decode a discovery message many times, and thereby makes it possible to reduce the processing load of the receiving user device 2b. Also, using the formats of FIG. 8 makes it possible to prevent the user device 2 from trying to decode a discovery message based on different data lengths, and thereby reduce the risk that the user device 2 falsely detects the discovery message.

### (Resource Allocation Process at Base Station)

Next, a resource allocation process performed by the communication system of the present embodiment is described. This resource allocation process is based on an assumption that the Type 1 allocation scheme, where the base station 1 performs allocation of PSDCH resources, is employed.

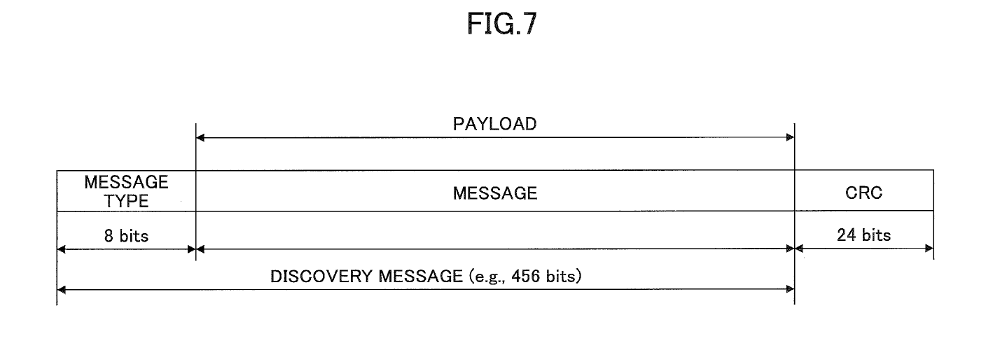

FIG. 9 is a sequence chart illustrating an example of a resource allocation process in a communication system according to an embodiment.

At step S101, the transmitting user device 2a transmits a resource allocation request signal to the base station 1 to request the base station 1 to allocate PSDCH resources for transmission of a discovery message. The resource allocation request signal may be, for example, an RRC control signal.

At step S102, the base station 1 reports the allocated PSDCH resources to the user device 2a.

Below, step S101 and step S102 are described in more detail.

### [Process (1)]

As a process (1), the user device 2a may include, in the resource allocation request signal to be transmitted to the base station 1 at step S101, an identifier indicating whether a discovery message with a normal data size or a discovery message with a large data size is to be transmitted, and the number of types of discovery messages intended to be transmitted in the PSDCH resource pool in the same interval.

The number of types of discovery messages intended to be transmitted indicates the number of discovery messages of different types that the user device 2a intends to transmit. For example, when the user device 2a intends to transmit two types of discovery messages concurrently in the PSDCH resource pool in the same interval, the user device 2a includes “2” in the resource allocation request signal as the number of types of discovery messages intended to be transmitted, and transmits the resource allocation request signal to the base station 1.

In this process, the base station 1 allocates PSDCH resources to the user device 2a by using one of the resource allocation methods described with reference to FIGS. 4 through 6 according to the amount of resources requested by the user device 2a.

For example, when the user device 2a intends to transmit one discovery message with a large data size, the base station 1 may use one of the resource allocation methods illustrated by FIGS. 5 and 6; or when the amount of available resources is small, the base station 1 may use one of the resource allocation methods illustrated by FIG. 4 and cause the user device 2a to divide the discovery message into parts and store the parts of the discovery message in the allocated resources.

As another example, when the user device 2a intends to transmit two (types of) discovery messages with a large data size, the base station 1 may allocate resources for each of the two discovery messages by using one of the resource allocation methods illustrated by FIGS. 5 and 6.

### [Process (2)]

As a process (2), the user device 2a may include, in the resource allocation request signal to be transmitted to the base station 1 at step S101, only the number of types of discovery messages intended to be transmitted in the PSDCH resource pool in the same interval. In this case, the data size of the discovery messages that the user device 2a intends to transmit is the same as the data size of the related-art discovery message.

In the process (2), when transmitting a discovery message with a large data size, the user device 2a divides the data of the discovery message into parts each of which can be stored in the related-art discovery message, and reports the number of the parts to the base station 1 as the number of types of discovery messages intended to be transmitted in the PSDCH resource pool in the same interval.

In this case, the user device 2a stores the parts of the divided discovery message in resources allocated by the base station 1 by using one of the discovery message formats described with reference to FIG. 8.

In the process (3), the base station 1 recognizes that the size of resources requested by the user device 2a is the data size of the related-art discovery message. Accordingly, the base station 1 allocates PSDCH resources to the user device 2a by using one of the resource allocation methods described with reference to FIGS. 4 and 6. For example, when the user device 2a intends to transmit two (types of) discovery messages, the base station 1 may allocate resources for each of the two discovery messages by using one of the resource allocation methods illustrated by FIG. 6.

Also in the process (2), when requesting resource allocation at step S101, the user device 2a may report the number of types of discovery messages intended to be transmitted by using a discTxResourceReq message included in a SidelinkUEInfomation signal that is one of RRC control signals.

The above described process is performed by the communication system of the present embodiment when the Type 1 allocation scheme, where the base station 1 performs allocation of PSDCH resources, is employed.

### (PSDCH Repetition Interval)

As described above with reference to FIG. 3 (a), the PSDCH resource pool is allocated periodically at an interval of 320 ms or greater in the time axis direction. Accordingly, the user device 2 can transmit discovery messages only at an interval of 320 ms or greater.

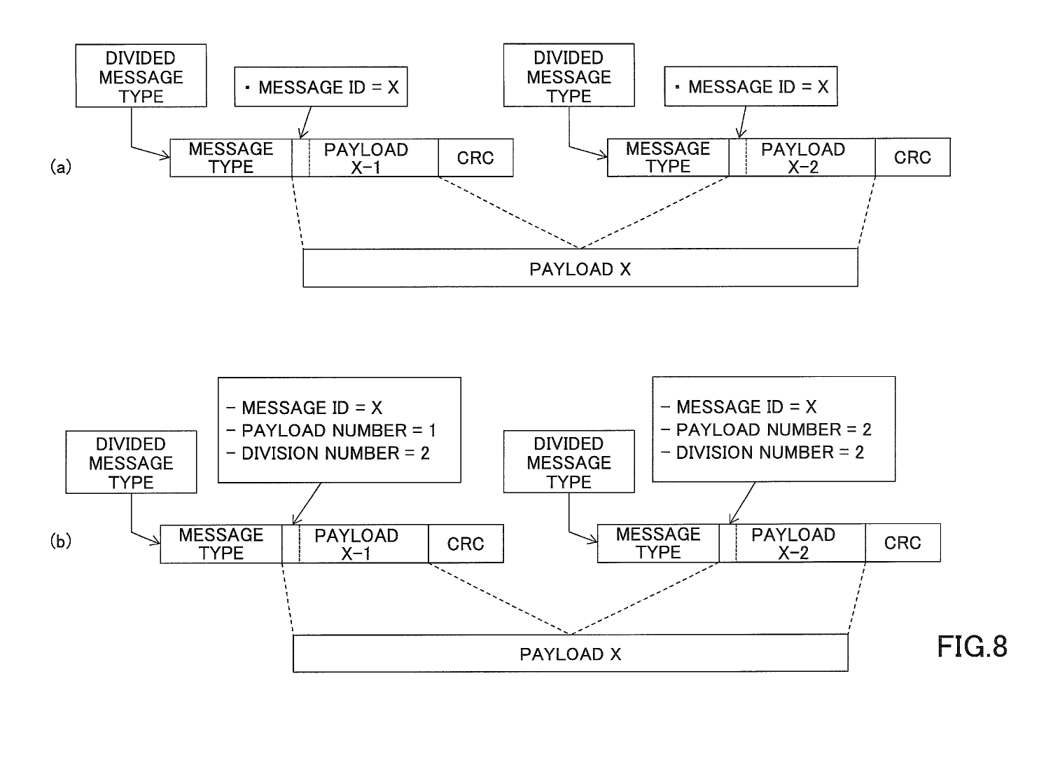

FIG. 10 is a drawing illustrating exemplary virtual resource pools set in the PSDCH resource pool. In FIG. 10, one PSDCH resource pool is divided into multiple virtual resources pools, and each of the base station 1 and the user device 2 stores information (e.g., identifiers) for uniquely identifying the virtual resource pools.

When transmitting a resource allocation request signal to the base station 1, the user device 2a specifies multiple virtual resource pools to request resource allocation by using the information for identifying the virtual resource pools. For example, the user device 2a specifies virtual resource pools V1 and V2 in FIG. 10, and the base station 1 repeatedly allocates PSDCH resources to the virtual resource pools V1 and V2.

The base station 1 may be configured to report the information for uniquely identifying the virtual resource pools to the user device 2 via, for example, an RRC control signal or system information.

This method enables the communication system of the present embodiment to control the transmission interval (repetition interval) of a discovery message.

Also, this method enables the user device 2 in the communication system of the present embodiment to transmit a discovery message via PSDCH at an interval shorter than 320 ms.

### <Transmission Process Using PSSCH and PSCCH>

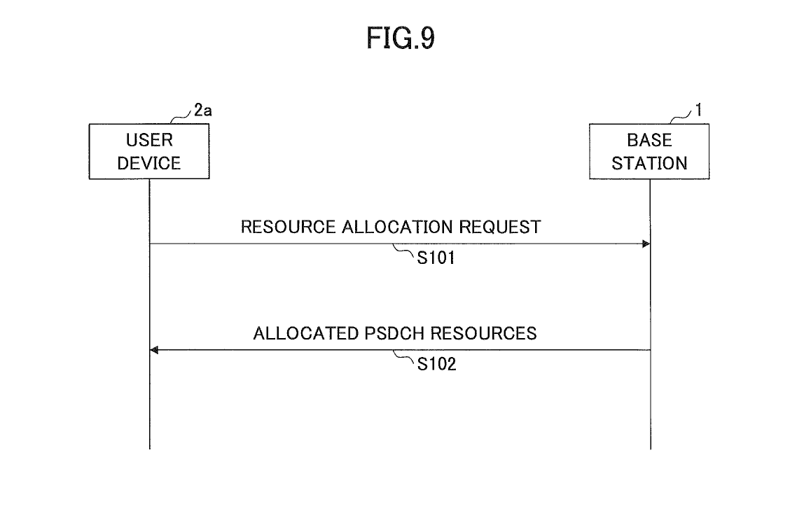

FIG. 11 is a drawing used to describe a related-art method of allocating PSCCH and PSSCH resources. As illustrated by FIG. 11, among all uplink resources, PSCCH and PSSCH resource pools are allocated inside of resources allocated for PUCCH. The resource pools of PSCCH and PSSCH are divided into upper parts and lower parts. Also, the PSCCH and PSSCH resource pools are allocated periodically at an interval of 40 ms or greater in the time axis direction. This interval is reported from the base station 1 to the user device 2 via, for example, system information or an RRC signal. PSCCH contains sidelink control information (SCI) that indicates locations of allocated resources in PSSCH. SCI is stored in one physical resource block (PRB). The receiving user device 2b can identify the locations of resources in PSSCH allocated to the receiving user device 2b by referring to SCI. Thus, SCI has a role similar to that of downlink control information (DCI) included in a physical downlink control channel (PDCCH).

As described above, PSSCH stores data such as VoIP data used for the communication service. The data is divided into multiple MAC PDUs, and each of the MAC PDUs is transmitted repeatedly up to four times including the initial transmission. Also, different from PSDCH, resources for storing MAC PDUs are repeatedly allocated to the user device 2 in one PSSCH resource pool on the time axis. Because PSDCH is a physical channel used for transmission of a discovery message, there is not much need to repeatedly allocate resources to the same user device 2 in the same PSDCH resource pool. On the other hand, because PSSCH is a physical channel used for transmission of data such as VoIP data in the communication service, it is necessary to repeatedly allocate resources on the time axis.

### (Repetition Interval of PSCCH and PSSCH)

A discovery message is transmitted like a broadcast signal from the transmitting user device 2a without specifying a destination user device 2. Accordingly, the user device 2 does not need to transmit a discovery signal frequently. On the other, because the related-art PSCCH and PSSCH resource pools are intended to be used for transmission of data such as VoIP data in the communication service, repetition intervals that can be set for PSCCH and PSSCH resource pools are shorter than those for PDSCH. For the above reasons, the communication system of the present embodiment may be configured such that a repetition interval of the PSCCH and PSSCH resource pools can be set at a value longer than the repetition interval in the related art.

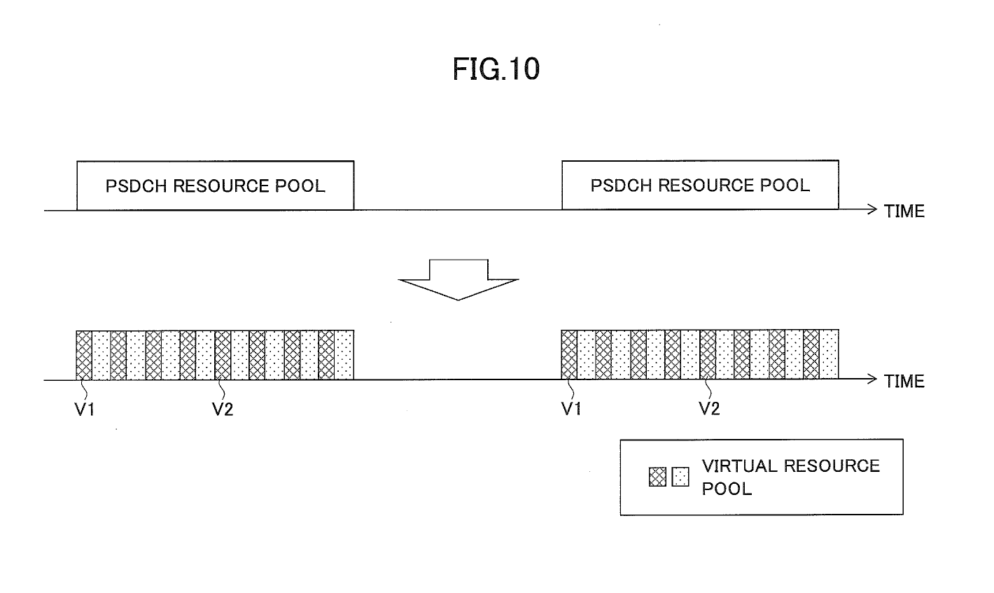

FIG. 12 is a drawing illustrating exemplary repetition intervals of PSCCH and PSSCH resource pools.

As illustrated by FIG. 12 (a), the PSCCH and PSSCH resource pools are set by using an “interval” indicating a repetition interval and an “offset value” indicating a section that is not allocated for resource pools used in D2D communication (i.e., a section used for normal UL communication). The “interval” and the “offset value” are reported from the base station 1 to the user device 2 via, for example, an RRC control signal.

FIG. 12 (b) illustrates examples of “interval” and “offset value” parameters. For example, new intervals (rf64, rf128, rf256, rf512, rf1024) may be assigned to unused parameters (spare6, spare5, spare4, spare3, spare2, spare1) in the related-art “interval” parameters. Here, rf64 indicates 64 radio frames (640 ms). Similarly, rf128 indicates 128 radio frames, rf256 indicates 256 radio frames, rf512 indicates 512 radio frames, and rf1024 indicates 1024 radio frames. Also, “sf” in FIG. 12 (b) indicates a subframe. That is, sf40 indicates 40 subframes (40 ms).

Also, in the “offset value” parameters of FIG. 12 (b), “small-r12” indicates an offset value for PSCCH and PSSCH, and “large-r12” indicates an offset value for PSDCH. In the communication system of the present embodiment, the offset value indicated by “large-r12” may also be applied to PSCCH and PSSCH.

### (Resource Allocation to Discovery Message)

Next, a resource allocation method used in the communication system of the present embodiment when a discovery message is transmitted using PSCCH and PSSCH is described.

Because the related-art PSSCH is a physical channel used for transmission of data such as VoIP data in the communication service, resources are repeatedly allocated on the time axis. For this reason, the transmitting user device 2a of the present embodiment stores information (which is hereafter referred to as a “time offset”) indicating the location of an allocated PSSCH resource on the time axis in SCI of PSCCH, and stores a MAC PDU containing a discovery message in the PSSCH resource indicated by the time offset.

### [Time Offset Setting (1)]

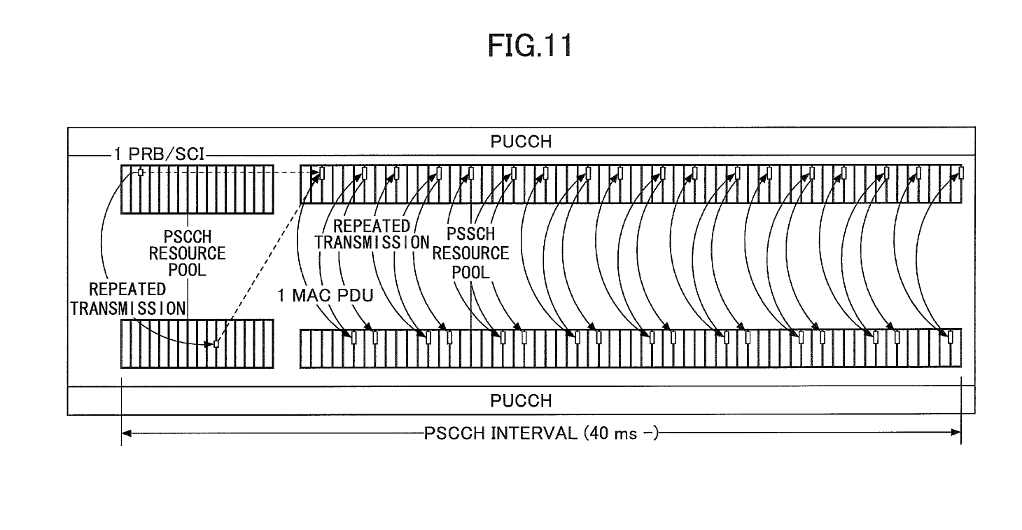

FIG. 13 is a drawing illustrating an example of a time offset setting (1) according to an embodiment. In FIG. 13, sections indicated by #0 through #7 correspond to subframes on the time axis of PSSCH. The “time offset” indicates the location of a PSSCH subframe. For example, a time offset “0” indicates PSSCH subframe #0.

FIG. 13 (a) illustrates an example of SCI indicating that one MAC PDU is transmitted in subframe #5. FIG. 13 (b) illustrates an example of SCI indicating that two MAC PDUs are transmitted in subframes #5 and #6.

### [Time Offset Setting (2)]

As illustrated by FIG. 11, in the related-art PSSCH, multiple resources are allocated such that the same MAC PDU can be repeatedly transmitted up to four times, and the multiple resources are repeatedly allocated in the same PSSCH resource pool. Therefore, the “time offset” may indicate a section corresponding to a unit of repetition of the multiple resources.

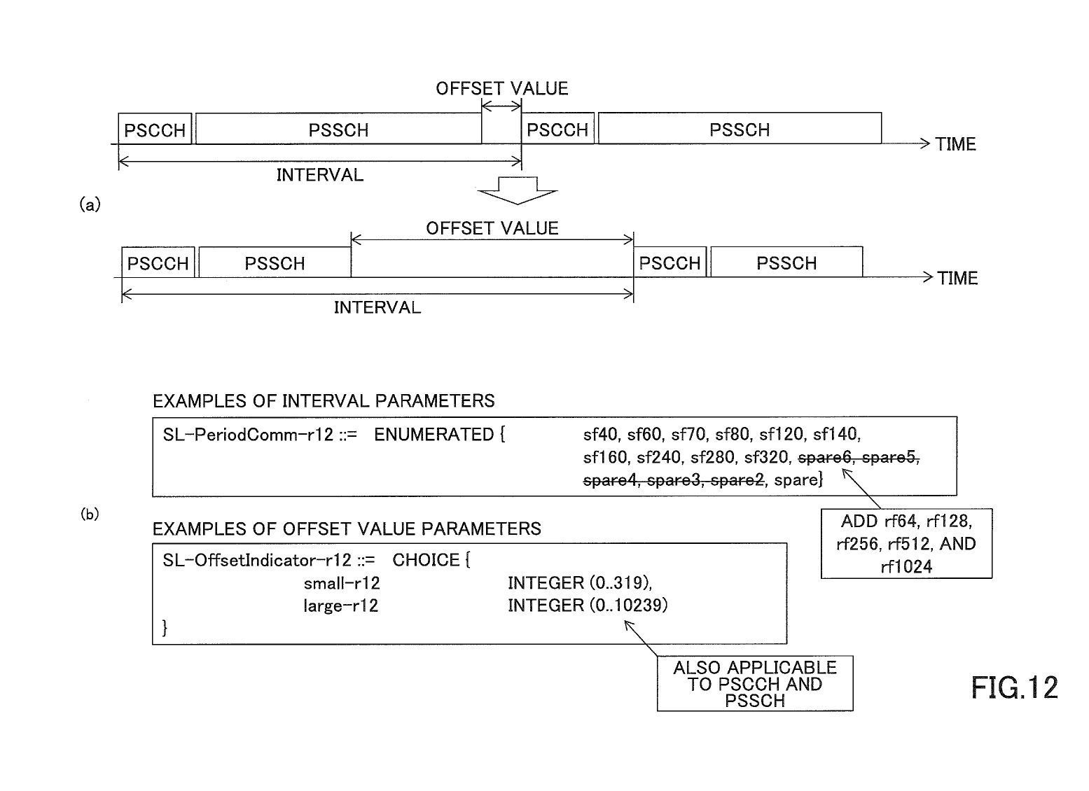

FIG. 14 is a drawing illustrating an example of a time offset setting (2) according to an embodiment. In the example of FIG. 14, the “time offset” indicates a section corresponding to a unit of repetition of the multiple resources. FIG. 14 (b) is an enlarged view of section #5 in FIG. 14 (a).

Assuming that the unit of “time offset” is a subframe as illustrated in FIG. 13 and the length of PSSCH is 1024 radio frames, the maximum value of the time offset is 10240. In this case, 14 bits are necessary for a field for setting the “time offset”. On the other hand, when it is assumed that the “time offset” indicates a section composed of four subframes as illustrated in FIG. 14, the maximum value of the time offset becomes 10240/4=2560. In this case, the size of the field for the “time offset” is reduced to 12 bits.

### [Time Offset Setting (3)]

In the communication system of the present embodiment, to reduce the number of bits of the field for setting the “time offset”, the “time offset” may be defined to indicate multiple sections grouped according to a predetermined rule.

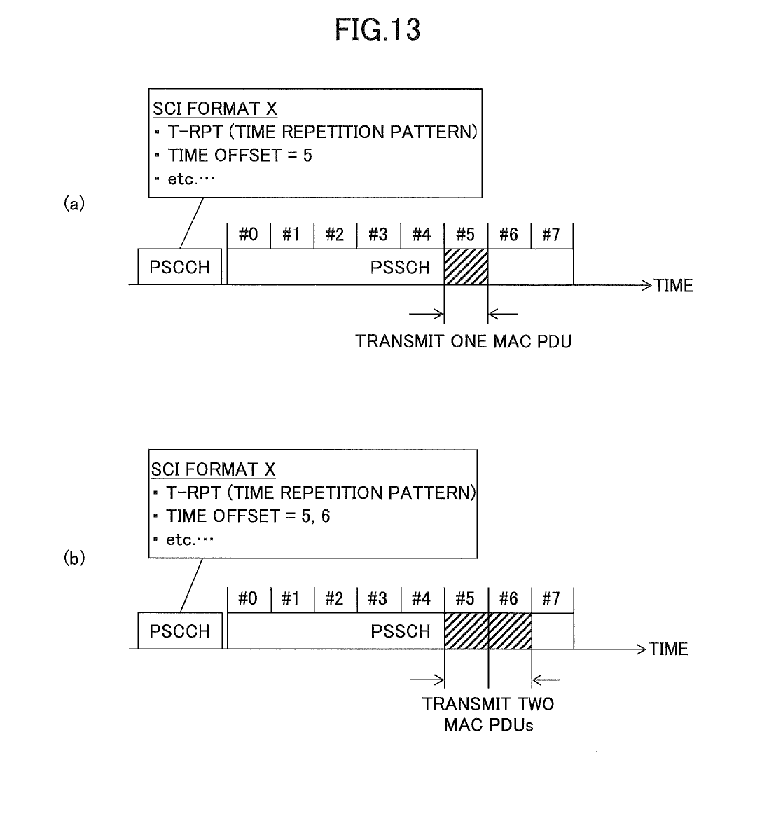

FIG. 15 is a drawing illustrating an example of a time offset setting (3) according to an embodiment. In the example of FIG. 15, a time offset “2” indicates either one of sections #4 and #5 in PSSCH.

In this case, the receiving user device 2b may determine one of the sections indicated by the time offset according to methods as described below.

For example, the user device 2b may try to decode both of a first section and a second section (#4 and #5 in FIG. 15), and determine one of the sections that is correctly decoded (CRC matched) as the section indicated by the time offset.

As another example, whether a time offset indicates a first section or a second section may be predetermined as a specification between the transmitting user device 2a and the receiving user device 2b.

As another example, the base station 1 may report, in advance, information indicating whether a time offset indicates a first section or a second section to the transmitting user device 2a and the receiving user device 2b.

Also, a parameter other than the “time offset” in SCI may be used to indicate whether a time offset indicates a first section or a second section. As an example of a parameter other than the “time offset”, SCI includes a parameter called “group destination ID”. For example, the group destination ID may be used such that when a predetermined bit in the group destination ID is “0”, the “time offset” indicates an even-numbered section (#4 in the example of FIG. 15); and when the predetermined bit is “1”, the “time offset” indicates an odd-numbered section (#5 in the example of FIG. 15).

Thus, in the process described above, the transmitting user device 2a of the present embodiment stores a “time offset” in SCI of PSCCH, and stores a MAC PDU containing a discovery message in a PSSCH resource indicated by SCI.

In the present embodiment, the time offset setting method described in [TIME OFFSET SETTING (3)] may be combined with the time offset setting method described in [TIME OFFSET SETTING (1)] or the time offset setting method described in [TIME OFFSET SETTING (2)]. This makes it possible to further reduce the size of the field for setting the “time offset”.

### (SCI Format)

Next, an exemplary configuration of an SCI format is described.

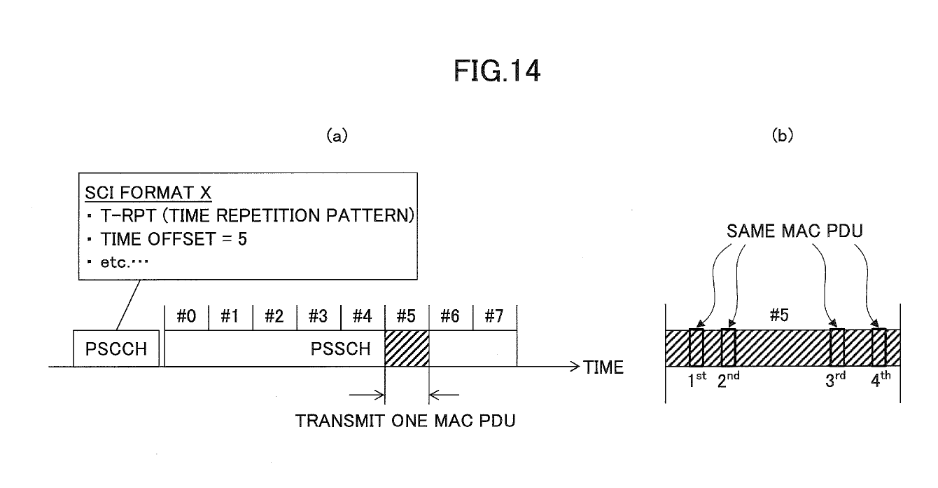

FIG. 16 is a drawing illustrating a part of related-art SCI (format 0). As illustrated by FIG. 16, SCI includes MCS (5 bits), timing advance (TA) (11 bits), and a group destination ID (8 bits). MCS indicates MCS settings (a modulation scheme, a coding scheme, etc.) of data stored in PSSCH. TA indicates transmission timing of PSSCH. The group destination ID indicates a destination (a group of user devices 2b) of data stored in PSSCH.

Here, according to the specification of D2D communication defined in the current LTE, 64 QAM cannot be set as MCS of PSSCH. Also, because a discovery message is not transmitted frequently like data used for the communication service, the discovery message may not greatly interfere with uplink signals (uplink signals in a macro cell) even when the transmission timing of PSSCH is set at 0 (TA=0). Further, unlike data used for the communication service, a discovery message is transmitted like a broadcast signal from the transmitting user device 2a without specifying a destination user device 2. Therefore, it is not necessary to set a group destination ID for the discovery message.

For the above reasons, in the communication system of the present embodiment, the user device 2a may store a “time offset” in a region normally assigned to store TA and a group destination ID, and may set 64 QAM as MCS. Also, when 64 QAM is set as MCS, the user device 2b may determine that a “time offset” is stored in a region normally assigned to store TA and a group destination ID.

The size of the region assigned to store TA and the group destination ID is 19 (11+8) bits. As described above, when the unit of “time offset” is a subframe, 14 bits are necessary to store the “time offset”. However, with the communication system of the present embodiment, even when the unit of “time offset” is a subframe, it is possible to store the “time offset” in SCI without exceeding the data size of the related-art SCI format.

The user device 2 may use the SCI format defined as described above for communication.

### (MAC PDU Format)

Next, an exemplary configuration of a MAC PDU format for storing a discovery message is described.

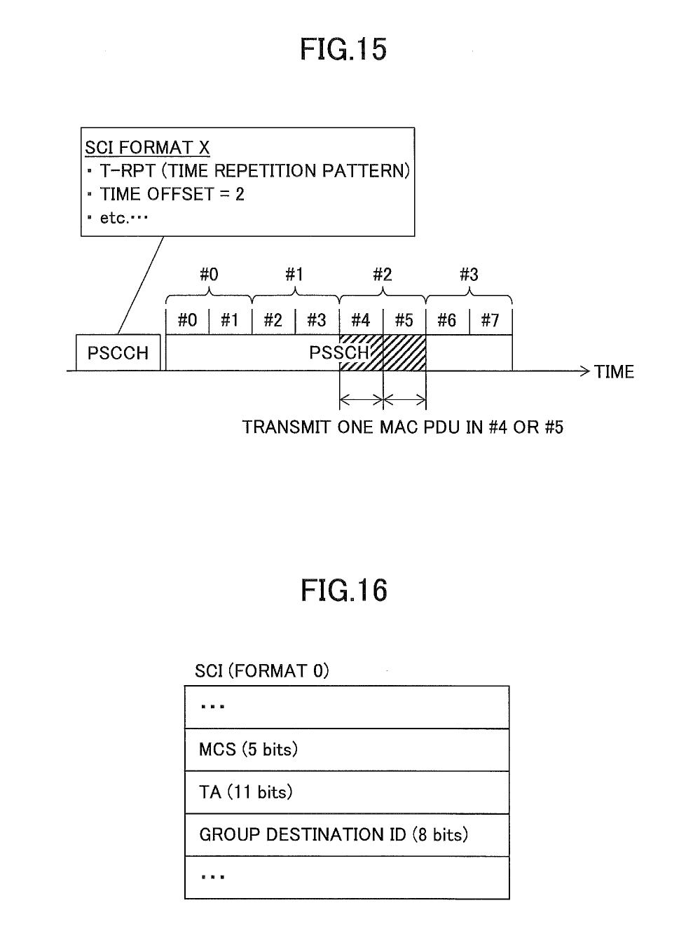

FIG. 17 is a drawing illustrating a related-art MAC PDU format. As described above, unlike data used for the communication service, a discovery message is transmitted like a broadcast signal without specifying a destination user device 2. Accordingly, SRC and DST included at the beginning of the MAC header are not necessary.

For this reason, in the communication system of the present embodiment, the user device 2a may be configured to remove SRC and DST fields at the beginning of the MAC header, and set, in the MAC header, a new version number indicating that a discovery message is stored in the MAC PDU. Also, the user device 2b may be configured to recognize that SCR and DST are not included in the MAC header when the new version number is set in the MAC header. This makes it possible to reduce the size of the MAC header by 40 bits.

Also, in the communication system of the present embodiment, the user device 2a stores a discovery message with one of the formats illustrated by FIGS. 7 and 8 in the MAC PDU. In the formats illustrated by FIGS. 7 and 8, the “message type” corresponds to a header. Therefore, the header of a discovery message is included in the payload of the MAC PDU.

In the communication system of the present embodiment, the user device 2a may store the “message type” of a discovery message in the MAC header.

### (Resource Allocation Process at Base Station)

Next, a resource allocation process performed by the communication system of the present embodiment is described. This resource allocation process is based on an assumption that a Mode 1 allocation scheme, where the base station 1 performs allocation of PSSCH resources, is employed.

In the Mode 1 allocation scheme, the base station 1 requests the user device 2a to report, at predetermined intervals, a buffer amount indicating the size of data to be transmitted by the user device 2a, and changes the amount of resources allocated to PSSCH based on the reported buffer amount.

Here, in the discovery service, different from data for the communication service, the same discovery message is transmitted at predetermined intervals. That is, the data size of the discovery message is constant. Accordingly, when the data size of the discovery message is known, the base station 1 can determine the amount of resources to be allocated to PSSCH without receiving reports of the buffer amount from the user device 2a at predetermined intervals.

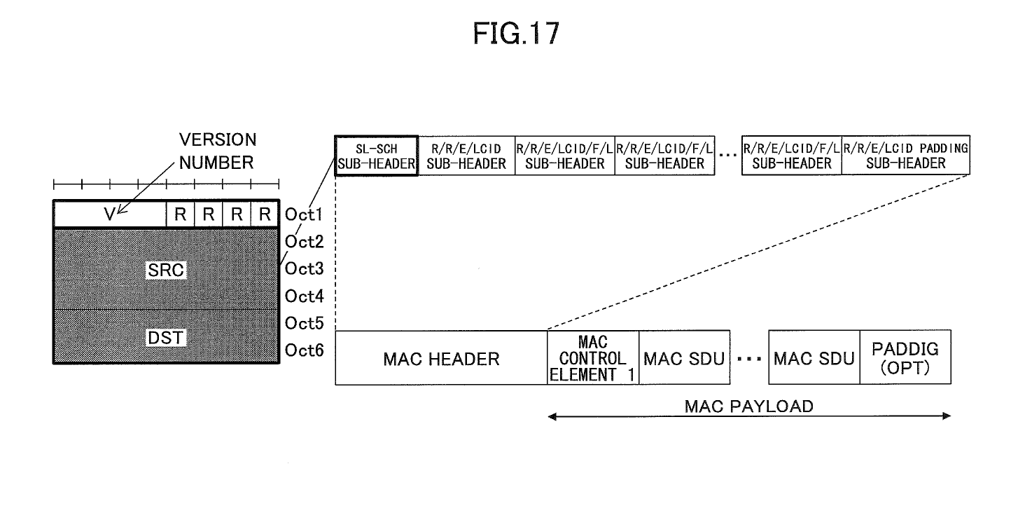

FIG. 18 is a sequence chart illustrating an example of a resource allocation process in a communication system according to an embodiment.

At step S201, the transmitting user device 2a transmits a resource allocation request signal to the base station 1 to request the base station 1 to allocate PSSCH resources for transmission of a discovery message. The resource allocation request signal may be, for example, an RRC control signal or a control signal in the MAC layer.

The resource allocation request signal may include the data size(s) of a discovery message(s), the number of types of discovery messages that the user device 2a intends to transmit, and the transmission interval of the discovery message(s). The transmission interval of the discovery message may be, for example, once in one PSSCH resource pool or once in three PSSCH resource pools. Thus, a transmission interval that spans multiple PSSCH resource pools may also be specified.

Below, an exemplary case where a control signal in the MAC layer such as Sidelink BSR (Buffer Status Report) MAC CE (Control Element) is used as the resource allocation request signal is described.

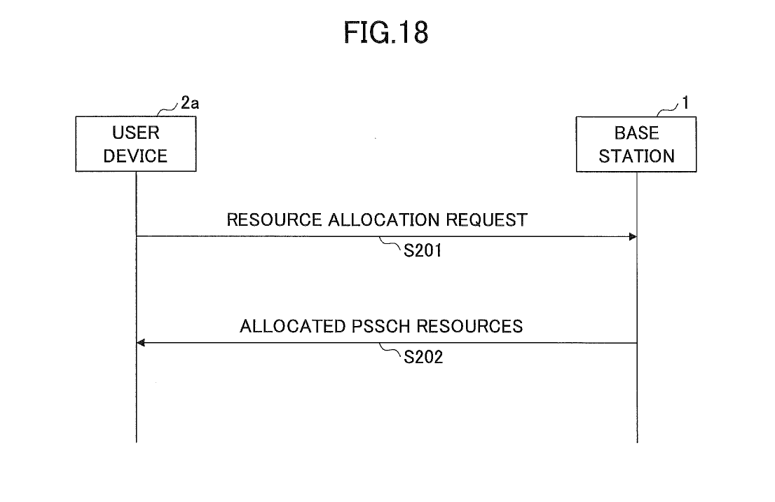

FIG. 19 is a drawing illustrating a Sidelink BSR MAC CE format. As illustrated by FIG. 19, Sidelink BSR MAC CE includes a field for storing a group index, a field for storing a logical channel group (LCG), and a field for storing a buffer size. These fields are contained repeatedly in Sidelink BSR MAC CE. FIG. 19 (a) illustrates a format for a case where the number of repetitions is an even number, and FIG. 19 (b) illustrates a format for a case where the number of repetitions is an odd number.

In the present embodiment, the user device 2a may be configured to store the data size of a discovery message in the field for storing a buffer size, and set a new ID in LCG ID. Also, the base station 1 may be configured to determine that the data size of a discovery message is stored in the field for storing a buffer size when the new ID is set in LCG ID, and to allocate PSSCH resources to the user device 2a.

Also, when transmitting multiple types of discovery messages, the user device 2a may set different LCG IDs for the respective types of discovery messages. In this case, the base station 1 may allocate PSSCH resources to the user device 2a for each of LCG IDs.

Further, the user device 2a may set the transmission interval of the discovery message in, for example, the field for storing a group index. In this case, the base station 1 may repeatedly allocate PSSCH resources to the user device 2a based on the transmission interval set in the field for storing a group index.

Also, in the communication system of the present embodiment, the setting range of a Sidelink BSR timer may be expanded. The Sidelink BSR timer indicates an interval at which the user device 2a transmits BSR to the base station 1. Expanding the setting range of the BSR timer enables the user device 2a to reduce the frequency of reporting BSR to the base station 1. Referring back to FIG. 18, at step S202, the base station 1 reports allocated PSCCH and PSSCH resources to the user device 2a.

The base station 1 may report the allocated PSSCH resources to the user device 2a by using an RRC control signal or using DCI of PDCCH. When DCI is used for the reporting, to avoid frequent transmission and reception of DCI, the base station 1 may report an allocation period via DCI or RRC, and allocate transmission resources for multiple PSCCH intervals by transmitting DCI once. Also, the base station 1 may be configured to release the allocated resources by using DCI.

Also, the base station 1 may be configured to report a “time offset” illustrated in FIGS. 13 through 15 to the user device 2a to report the location of an allocated PSSCH resource to the user device 2a. Also, the base station 1 may be configured to not report the “time offset” to the user device 2a and repeatedly allocate resources in the same PSSCH resource pool as illustrated by FIG. 11. In this case, the user device 2a may be configured to randomly select a resource for storing a discovery message from the allocated resources.

### (Method for Setting PSSCH Repetition Interval)

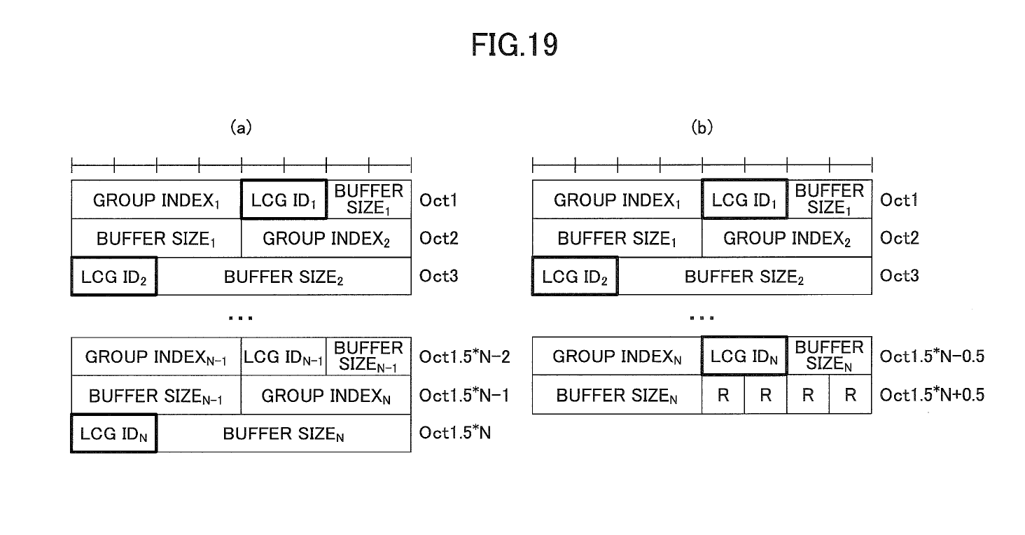

FIG. 20 is a drawing illustrating exemplary virtual resource pools set in a PSSCH resource pool(s). FIG. 20 (a) illustrates a case where a virtual resource pool is set in each of predetermined resource pools in PSSCH resource pools. On the other hand, FIG. 20 (b) illustrates a case where multiple virtual resource pools are set in a PSSCH resource pool.

The base station 1 and the user device 2 store information (e.g., identifiers) for uniquely identifying the virtual resource pools.

For example, the base station 1 may be configured to report the information for uniquely identifying the virtual resource pools to the user device 2 via, for example, an RRC control signal or system information.

Using the information for uniquely identifying the virtual resource pools makes it easier to specify resources in the communication system of the present embodiment.

For example, the user device 2a may specify the transmission interval of a discovery message in the resource allocation request signal transmitted at step S201 of FIG. 18 by using information for uniquely identifying virtual resource pools as those illustrated in FIG. 20 (a).

Also, instead of the “time offset” transmitted at step S202, the base station 1 may use information for uniquely identifying virtual resource pools as those illustrated in FIG. 20 (b) to report the location of a resource allocated to PSSCH to the user device 2a.

### <Functional Configurations>

Examples of functional configurations of the base station 1 and the user device 2 that perform processes of the present embodiment are described below.

### (Base Station)

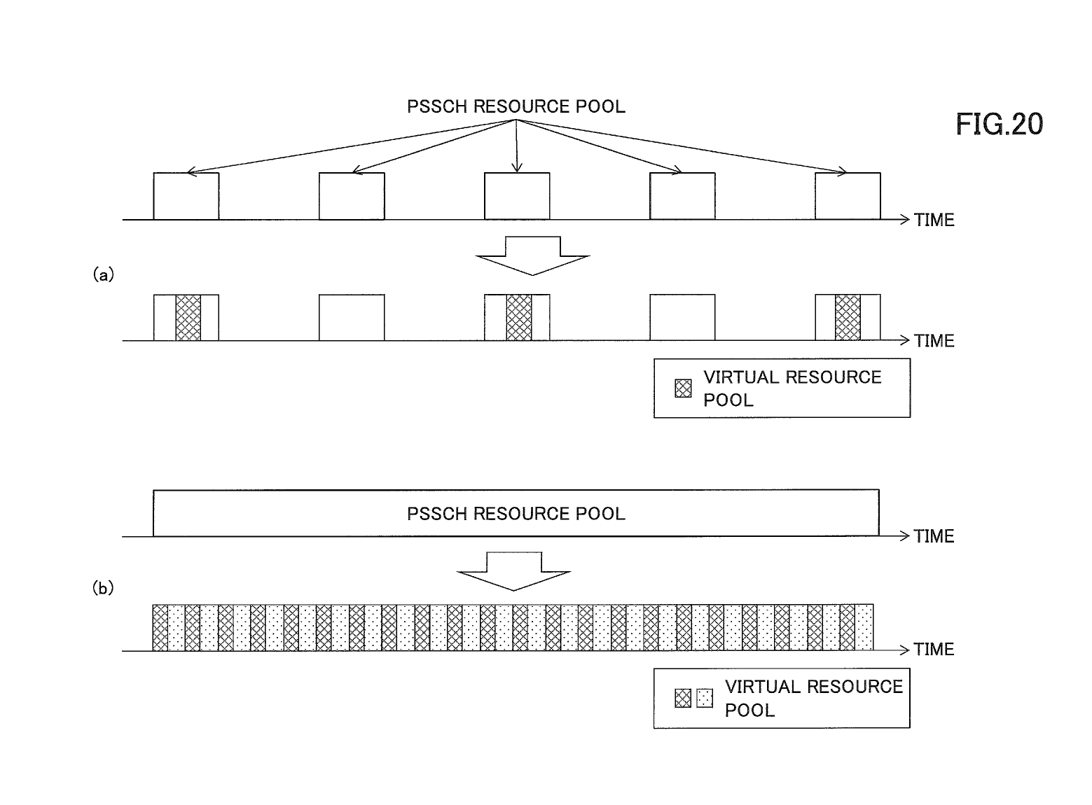

FIG. 21 is a drawing illustrating an example of a functional configuration of a base station according to an embodiment. As illustrated by FIG. 21, the base station 1 includes a signal transmitter 301, a signal receiver 302, a resource pool setter 303, and a resource allocator 304. FIG. 21 illustrates only functional components of the base station 1 that are particularly relevant to the present embodiment, and the base station 1 may also at least include unshown functional components that are necessary for operations conforming to LTE. Also, the functional configuration of FIG. 21 is just an example. As long as operations related to the present embodiment can be performed, the categorization and the names of the functional components may be freely changed.

The signal transmitter 301 includes a function to generate various physical layer signals from upper layer signals to be transmitted from the base station 1, and to wirelessly transmit the physical layer signals. The signal receiver 302 includes a function to wirelessly receive various signals from the user device 2, and obtain upper layer signals from the received physical layer signals.

The resource pool setter 303 sets, in an uplink signal, a PSDCH resource pool(s) or PSCCH and PSSCH resource pools used for D2D communication, and reports the set resource pools via an RRC signal or system information to the user device 2. Also, the resource pool setter 303 may be configured to set virtual resource pools in the PSDCH resource pool(s) or the PSSCH resource pool(s), and report information for uniquely identifying the set virtual resource pools to the user device 2.

The resource allocator 304 allocates resources in the PSDCH resource pool or the PSSCH resource pool to the user device 2 in response to a request from the user device 2. When allocating resources in the PSDCH resource pool to the user device 2, the resource allocator 304 may allocate multiple resources that are consecutive in the frequency direction or multiple resources that are arranged in the time axis direction at a predetermined interval (e.g., X ms) according to a request from the user device 2. Also, the resource allocator 304 may repeatedly allocate multiple resources in specific locations in the PSDCH resource pool according to a request from the user device 2.

Further, when allocating resources in the PSSCH resource pool to the user device 2, the resource allocator 304 may allocate a resource in a specific location (e.g., one location) in the PSSCH resource pool, and transmit a “time offset” indicating the location of the allocated resource to the user device 2 via, for example, an RRC signal or DCI.

### (User Device)

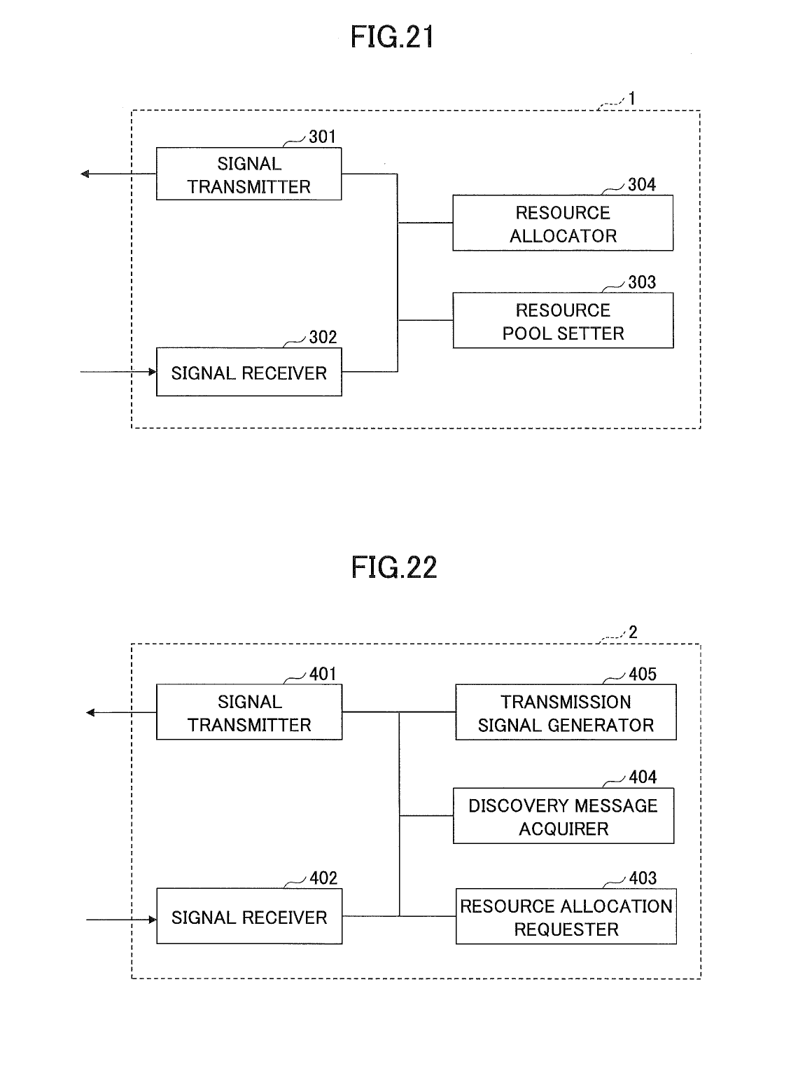

FIG. 22 is a drawing illustrating an example of a functional configuration of a user device according to an embodiment. As illustrated by FIG. 22, the user device 2 includes a signal transmitter 401, a signal receiver 402, a resource allocation requester 403, a discovery message acquirer 404, and a transmission signal generator 405. FIG. 22 illustrates only functional components of the user device 2 that are particularly relevant to the present embodiment, and the user device 2 may also at least include unshown functional components that are necessary for operations conforming to LTE. Also, the functional configuration of FIG. 22 is just an example. As long as operations related to the present embodiment can be performed, the categorization and the names of the functional components may be freely changed.

The signal transmitter 401 generates various physical layer signals from upper layer signals to be transmitted from the user device 2, and wirelessly transmits the physical layer signals. The signal transmitter 401 also includes a transmission function for D2D communication and a transmission function for cellular communication.

The signal receiver 402 includes functions to wirelessly receive various signals from other user devices 2 or the base station 1, and obtain upper layer signals from the received physical layer signals. The signal receiver 402 also includes a reception function for D2D communication and a reception function for cellular communication.

The resource allocation requester 403 requests the base station 1 to allocate PSDCH or PSSCH resources as necessary. The resource allocation requester 403 may request the base station 1 to allocate resources by using, for example, an RRC control signal or a MAC layer control signal.

Also, the resource allocation requester 403 may request the base station 1 to allocate resources by specifying a virtual resource pool(s) set in the PSDCH resource pool or the PSSCH resource pool.

The discovery message acquirer 404 communicates with, for example, a Proximity Service (ProSe) function on a communication network, and obtains a discovery message generated by the ProSe function.

The transmission signal generator 405 stores the discovery message obtained by the discovery message acquirer 404 in an allocated PSDCH resource or an allocated PSSCH resource, and thereby generates a transmission signal. Also, when storing the discovery message in the allocated PSSCH resource, the transmission signal generator 405 also stores a “time offset”, which indicates a location where the discovery message is stored, in SCI of PSCCH.

Also, when the data size of the discovery message is large, the transmission signal generator 405 may divide data of the discovery message into parts, and store the parts of the divided discovery message in multiple PSDCH resources or multiple PSSCH resources that are allocated to the user device 2.

Also, the transmission signal generator 405 may be configured to request the base station 1 to allocate PSDCH or PSSCH resources via the resource allocation requestor 403, or configured to randomly allocate resources in the PSDCH resource pool or the PSCCH and PSSCH resource pools to the discovery message by itself.

The entire functional configuration of each of the base station 1 and the user device 2 described above may be implemented by a hardware circuit(s) (e.g., one or more IC chips). Alternatively, a part of the functional configuration may be implemented by a hardware circuit(s) and the remaining part of the functional configuration may be implemented by a CPU and programs.

### (Base Station)

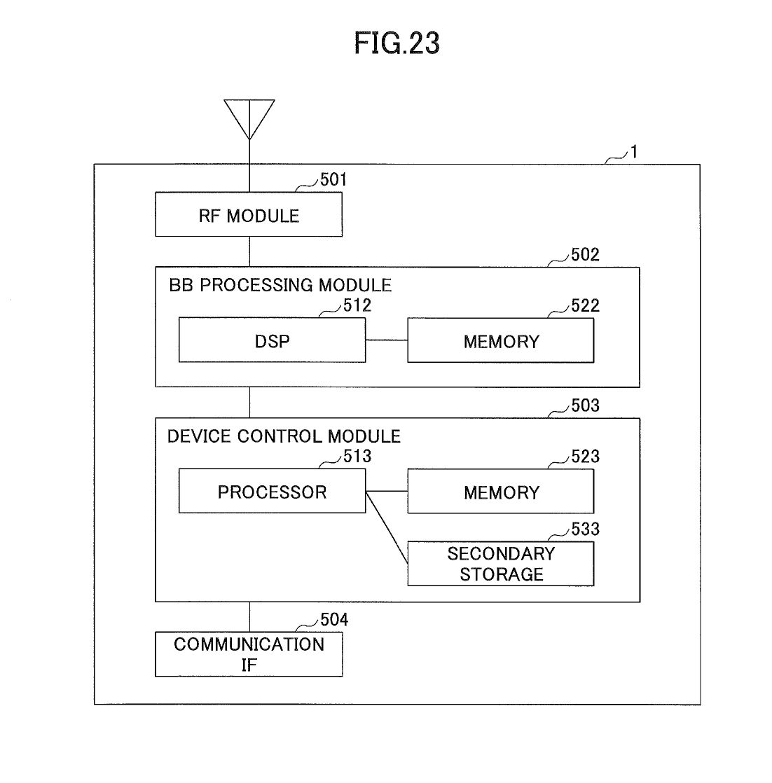

FIG. 23 is a drawing illustrating an example of a hardware configuration of a base station according to an embodiment. FIG. 23 illustrates a configuration that is closer than FIG. 21 to an actual implementation. As illustrated by FIG. 23, the base station 1 includes a radio frequency (RF) module 501 that performs processes related to radio signals, a baseband (BB) processing module 502 that performs baseband signal processing, a device control module 503 that performs processes in upper layers, and a communication IF 504 that is an interface for connecting with a network.

The RF module 501 performs processes such as digital-to-analog (D/A) conversion, modulation, frequency conversion, and power amplification on a digital baseband signal received from the BB processing module 502 to generate a radio signal to be transmitted from an antenna. Also, the RF module 501 performs processes such as frequency conversion, analog-to-digital (A/D) conversion, and demodulation on a received radio signal to generate a digital baseband signal, and inputs the digital baseband signal to the BB processing module 502. The RF module 501 may include, for example, a part of the signal transmitter 301 and a part of the signal receiver 302 in FIG. 21.

The BB processing module 502 converts an IP packet into a digital baseband signal and vice versa. A digital signal processor (DSP) 512 is a processor that performs signal processing in the BB processing module 502. A memory 522 is used as a work area of the DSP 512. The BB processing module 502 may include, for example, a part of the signal transmitter 301, a part of the signal receiver 302, and the resource allocator 304 in FIG. 21.

The device control module 503 performs protocol processing in the IP layer and operation and maintenance (OAM) processing. A processor 513 performs processes of the device control module 503. A memory 523 is used as a work area of the processor 513. A secondary storage 533 is, for example, an HDD and stores various settings for operations of the base station 1 itself. The device control module 503 may include, for example, the resource pool setter 303 in FIG. 21.

### (User Device)

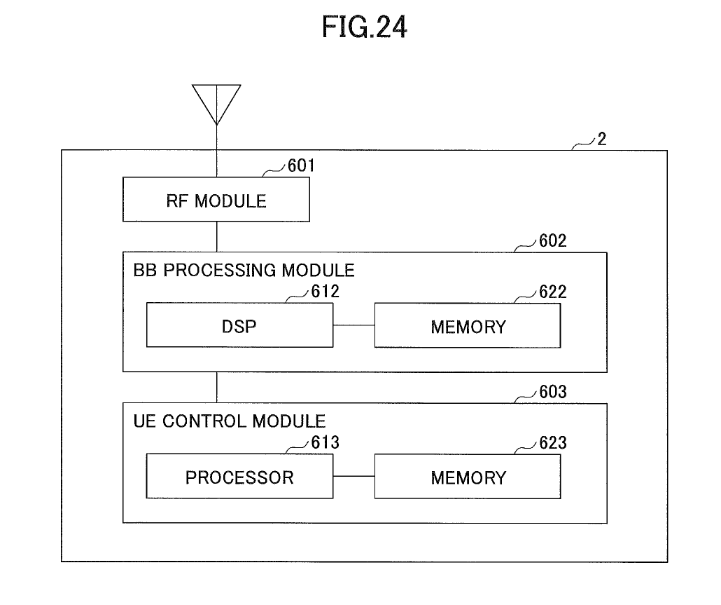

FIG. 24 is a drawing illustrating an example of a hardware configuration of a user device according to an embodiment. FIG. 24 illustrates a configuration that is closer than FIG. 22 to an actual implementation. As illustrated by FIG. 24, the user device 2 includes an RF module 601 that performs processes related to radio signals, a BB processing module 602 that performs baseband signal processing, and a UE control module 603 that performs processes in upper layers.

The RF module 601 performs processes such as D/A conversion, modulation, frequency conversion, and power amplification on a digital baseband signal received from the BB processing module 602 to generate a radio signal to be transmitted from an antenna. Also, the RF module 601 performs processes such as frequency conversion, A/D conversion, and demodulation on a received radio signal to generate a digital baseband signal, and inputs the digital baseband signal to the BB processing module 602. The RF module 601 may include, for example, a part of the signal transmitter 401 and a part of the signal receiver 402 in FIG. 22.

The BB processing module 602 converts an IP packet into a digital baseband signal and vice versa. A DSP 612 is a processor that performs signal processing in the BB processing module 602. A memory 622 is used as a work area of the DSP 612. The BB processing module 602 may include, for example, a part of the signal transmitter 401, a part of the signal receiver 402, the resource allocation requester 403, and the transmission signal generator 405 in FIG. 22.

The UE control module 603 performs protocol processing in the IP layer and processes related to applications. A processor 613 performs processes of the UE control module 603. A memory 623 is used as a work area of the processor 613. The UE control module 603 may include, for example, the discovery message acquirer 404 in FIG. 22.

### Effects

As described above, an embodiment of the present invention provides a user device used in a mobile communication system supporting D2D communication. The user device includes an acquirer that obtains a discovery message to be transmitted to another user device; a generator that divides the discovery message into two or more discovery messages, and stores the two or more discovery messages in two or more resource regions of a physical channel for the D2D communication to generate a transmission signal to be transmitted to the other user device; and a transmitter that transmits the transmission signal.

This user device 2 provides a technology that makes it possible to transmit a discovery message with a large data size.

The generator may be configured to store the two or more discovery messages in the two or more resource regions that are arranged in a frequency direction or a time direction and are associated with each other.

This configuration enables the user device 2 of the embodiment to repeat a discovery message in the PSDCH resource pool in the same interval at a repetition rate that is the same as the repetition rate in the related-art PSDCH resource allocation method, and to secure a coverage where the discovery message is transmitted.

The user device may also include a requester that requests a base station to allocate the two or more resource regions for transmitting the two or more discovery messages, and the generator may store the two or more discovery messages in the two or more resource regions allocated by the base station.

This configuration enables the user device 2 to transmit a discovery message with a large data size even when a Type 1 allocation scheme, where the base station 1 performs allocation of PSDCH resources, is employed.

The generator may be configured to divide the discovery message into the two or more discovery messages and to store, in a header field of each of the two or more discovery messages, information that indicates a correspondence among the two or more discovery messages and is used to combine the two or more discovery messages.

This configuration enables the receiving user device 2b to recognize that parts of a divided discovery message are stored in the payload fields of received multiple discovery messages.

The information indicating the correspondence may include an identifier for uniquely identifying the discovery message, a number of the two or more discovery messages, and information indicating a place in the order of combining the two or more discovery messages.

This configuration enables the receiving user device 2b to recognize that not all of discovery messages containing parts of a divided discovery message have been received (i.e., that one or more of the discovery messages are missing). Also with this configuration, even when the order of processing the discovery messages is changed for some reason, the receiving user device 2b can combine the parts of divided data of the discovery message in a correct order.

Another embodiment of the present invention provides a base station used in a mobile communication system supporting D2D communication. The base station includes a receiver that receives a resource allocation request from a user device; an allocator that allocates two or more resource regions of a physical channel used for the D2D communication to the user device based on the resource allocation request, the two or more resource regions being arranged in a frequency direction or a time direction and associated with each other; and a reporter that reports the allocated two or more resource regions to the user device.

This base station 1 provides a technology that makes it possible to transmit a discovery message with a large data size.

Another embodiment of the present invention provides a user device used in a mobile communication system supporting D2D communication. The user device includes an acquirer that obtains a discovery message to be transmitted to another user device; a generator that stores the discovery message in a resource region of a physical channel used for the D2D communication, stores offset information indicating a location of the resource region in a physical channel for a control signal used in the D2D communication, and thereby generates a transmission signal to be transmitted to the other user device; and a transmitter that transmits the transmission signal.

This user device 2 provides a technology that makes it possible to transmit a discovery message with a large data size.

The offset information may indicate a location of a subframe in a physical channel used for data communication in the D2D communication.

This configuration enables the user device 2 to specify a resource region in PSSCH where the discovery message is stored.

This configuration also makes it possible to prevent wasteful and repeated allocation of radio resources in PSSCH. Also, preventing wasteful and repeated allocation of radio resources in PSSCH makes it possible to reduce the power consumption of a terminal.

The user device 2 may also include a requester that transmits a request signal to request the base station to allocate resources in the physical channel for the D2D communication, and the request signal may include a data size of the discovery message and a transmission interval of the discovery message.

This configuration enables the user device 2 to transmit a discovery message with a large data size even when a Mode 1 allocation scheme, where the base station 1 performs allocation of PSSCH resources, is employed.

The request signal may be a BSR MAC CE, and the requester may be configured to set, in a field of the BSR MAC CE for storing a logical channel group, information indicating that the request signal includes the data size of the discovery message.

This configuration enables the user device 2 to request the base station 1 to allocate resources of PSSCH for storing the discovery message.

Components in the user device and the base station described above may also be referred to as “units”, “parts”, “circuits”, or “devices”.

### Supplementary Description of Embodiments

Embodiments of the present invention are described above. However, the present invention is not limited to the above-described embodiments, and a person skilled in the art may understand that variations, modifications, and replacements may be made to the above embodiments. Although specific values are used in the above descriptions to facilitate the understanding of the present invention, the values are just examples and other appropriate values may also be used unless otherwise mentioned. Grouping of subject matter in the above descriptions is not essential for the present invention. For example, subject matter described in two or more sections may be combined as necessary, and subject matter described in one section may be applied to subject matter described in another section unless they contradict each other. Boundaries of functional units or processing units in functional block diagrams do not necessarily correspond to boundaries of physical components. Operations of multiple functional units may be performed by one physical component, and an operation of one functional unit may be performed by multiple physical components. The order of steps in sequence charts and flowcharts described in the embodiments may be changed unless they do not become inconsistent. Although functional block diagrams are used to describe the user device 2 and the base station 1, the user device 2 and the base station 1 may be implemented by hardware, software, or a combination of them. Software to be executed by a processor of the user device 2 and software to be executed by a processor of the base station 1 according to the embodiments of the present invention may be stored in any appropriate storage medium such as a random access memory (RAM), a flash memory, a read-only memory (ROM), an EPROM, an EEPROM, a register, a hard disk drive (HDD), a removable disk, a CD-ROM, a database, or a server.

The present invention is not limited to the specifically disclosed embodiments, and variations and modifications may be made without departing from the scope of the present invention.

The discovery message acquirer 404 is an example of an acquirer. The transmission signal generator 405 is an example of a generator. The signal transmitter 401 is an example of a transmitter. The resource allocation requester 403 is an example of a requester. The signal receiver 302 is an example of a receiver. The resource allocator 304 is an example of an allocator.

The present application is based on and claims the benefit of priority of Japanese Patent Application No. 2015-080418 filed on Apr. 9, 2015, the entire contents of which are hereby incorporated herein by reference.

### EXPLANATION OF REFERENCE NUMERALS

1 Base station
2 User device
301 Signal transmitter
302 Signal receiver
303 Resource pool setter
304 Resource allocator
401 Signal transmitter
402 Signal receiver
403 Resource allocation requestor
404 Discovery message acquirer
405 Transmission signal generator
501 RF module
502 BB processing module
503 Device control module
504 Communication IF
601 RF module
602 BB processing module
603 UE control module

1. A user device used in a mobile communication system supporting D2D communication, the user device comprising:
an acquirer that obtains a discovery message to be transmitted to another user device;
a generator that divides the discovery message into two or more discovery messages, and stores the two or more discovery messages in two or more resource regions of a physical channel for the D2D communication to generate a transmission signal to be transmitted to the another user device; and
a transmitter that transmits the transmission signal.

2. The user device as claimed in claim 1, wherein the generator stores the two or more discovery messages in the two or more resource regions that are arranged in a frequency direction or a time direction and are associated with each other.

3. The user device as claimed in claim 1, further comprising:
a requester that requests a base station to allocate the two or more resource regions for transmitting the two or more discovery messages,
wherein the generator stores the two or more discovery messages in the two or more resource regions allocated by the base station.

4. The user device as claimed in claim 1, wherein the generator divides the discovery message into the two or more discovery messages and stores, in a header field of each of the two or more discovery messages, information that indicates a correspondence among the two or more discovery messages and is used to combine the two or more discovery messages.

5. The user device as claimed in claim 4, wherein the information indicating the correspondence includes an identifier for uniquely identifying the discovery message, a number of the two or more discovery messages, and information indicating a place in an order of combining the discovery messages.

6. A base station used in a mobile communication system supporting D2D communication, the base station comprising:
a receiver that receives a resource allocation request from a user device;
an allocator that allocates two or more resource regions of a physical channel used for the D2D communication to the user device based on the resource allocation request, the two or more resource regions being arranged in a frequency direction or a time direction and associated with each other; and
a reporter that reports the allocated two or more resource regions to the user device.

7. A user device used in a mobile communication system supporting D2D communication, the user device comprising:
an acquirer that obtains a discovery message to be transmitted to another user device;
a generator that stores the discovery message in a resource region of a physical channel used for the D2D communication, stores offset information indicating a location of the resource region in a physical channel for a control signal used in the D2D communication, and thereby generates a transmission signal to be transmitted to the another user device; and
a transmitter that transmits the transmission signal.

8. The user device as claimed in claim 7, wherein the offset information indicates a location of a subframe in a physical channel used for data communication in the D2D communication.

9. The user device as claimed in claim 7, further comprising:
a requester that transmits a request signal to request a base station to allocate resources in the physical channel for the D2D communication,
wherein the request signal includes a data size of the discovery message and a transmission interval of the discovery message.

10. The user device as claimed in claim 9, wherein
the request signal is a BSR MAC CE; and
the requester sets, in a field of the BSR MAC CE for storing a logical channel group, information indicating that the request signal includes the data size of the discovery message.

11. The user device as claimed in claim 2, further comprising:
a requester that requests a base station to allocate the two or more resource regions for transmitting the two or more discovery messages,
wherein the generator stores the two or more discovery messages in the two or more resource regions allocated by the base station.

12. The user device as claimed in claim 2, wherein the generator divides the discovery message into the two or more discovery messages and stores, in a header field of each of the two or more discovery messages, information that indicates a correspondence among the two or more discovery messages and is used to combine the two or more discovery messages.

13. The user device as claimed in claim 3, wherein the generator divides the discovery message into the two or more discovery messages and stores, in a header field of each of the two or more discovery messages, information that indicates a correspondence among the two or more discovery messages and is used to combine the two or more discovery messages.

14. The user device as claimed in claim 8, further comprising:
a requester that transmits a request signal to request a base station to allocate resources in the physical channel for the D2D communication,
wherein the request signal includes a data size of the discovery message and a transmission interval of the discovery message.
